(19) United States
(12) Patent Application Publication
(10) Pub. No.: US 2025/0005830 A1
(43) Pub. Date: Jan. 2, 2025

(54) System and Method for Generating Training Images for Training a Model to Classify Grains in a Sample Image and Identification of Impurities in a Sample Image

(71) Applicant: GROUND TRUTH AGRICULTURE INC., Regina (CA)

(72) Inventor: Syed Aamir Ali Shah, Regina (CA)

(21) Appl. No.: 18/756,715

(22) Filed: Jun. 27, 2024

Related U.S. Application Data
(60) Provisional application No. 63/511,015, filed on Jun. 29, 2023.

(51) Int. Cl. G06T 11/60; G06T 3/60; G06T 7/50; G06V 20/70

(52) U.S. Cl. CPC G06T 11/60; G06T 3/60; G06T 7/50; G06V 20/70; G06V 2201/07

(57) ABSTRACT

Images for training a grain detection model are generated by: providing a starting image, repeatedly selecting a polygon from annotated sample images of known polygons and modifying the starting image by placing the selected polygons in the starting image so that the resulting image comprises a random assortment of known polygons from different sources. Uniformly annotated grain sample images can thus be introduced to a in modified images without introducing bias to the model. In a further aspect, selected objects in a grain sample can be sized based on sizing apertures of a sizing device by defining a sizing polygon representing the sizing apertures and then iteratively positioning the selected object polygon relative to the sizing polygon so that the overlap amount can be compared to a threshold to distinguish grains from impurities without actually passing the grains through the sizing device.

This application claims the benefit under 35 U.S.C. 119 (e) of U.S. provisional application Ser. No. 63/511,015, filed Jun. 29, 2023.

### FIELD OF THE INVENTION

The present invention relates to a system and method for generating training images for training a detection model that detects and classifies polygons representing grains within a grain sample image into classes representing embodied grain characteristics of the grains within the sample. The present invention further relates to a system and method for identifying impurities or waste material within a grain sample image prior to grading analysis.

### BACKGROUND

Open-sourced deep learning algorithms operating on deep learning networks are available which can be used for identifying presence of a characteristic within image data, when trained using a large pool of image data. Specifically, these algorithms can be used to identify and then classify various types of grains.

The algorithm or detection model identifies multiple objects in an image and classifies those objects in different classes. More particularly, the model takes an image of grains as input and yields a list of results in which each result entry is comprised of a polygon, Polyᵢ, that is the iₜₕ polygon representing one of the detected objects in the image, where i={1, 2, 3, . . . , n}, n being the total number of predictions made by the algorithm. Cⱼ is prediction for a polygon to be in jₜₕ class where J={0, 1, 2, . . . , m−1}, m being the total number of classes to be predicted. P_{cj} is confidence of prediction in terms of probabilities, for Polyᵢ to be in class Cⱼ.

To train these models, annotated images are required in which polygons in the image are identified and defined as known objects having known characteristics. This image annotation process is time consuming and laborious, but is an equally important part of the process. To improve the accuracy and speed of annotations, grains of similar characteristics can be grouped together and captured in one image in which all polygons or grains in the image can be identified and annotated with an identified characteristic in a simple manner as each grain in the image is of same type. However, these types of annotated images in which all objects are of the same type are not very ideal for training the models because they introduce a bias that suggests to the model that one image can contain seeds of only one characteristic at a time. Thus, there is a need to develop a process that allows for large groups of images to be annotated in a reliable manner, but without resulting in images that introduce a bias when used to train a detection model.

Furthermore, in some instances it is desirable to train a detection model to distinguish between a primary grain type and one or more impurities such as other grain types which may be similar in physical characteristics. To accomplish this, grain sample images must be provided to the detection model for training which depict a realistic mixture of the grain with impurities; however, in view of the physical similarity between the grains and such impurities, actual mixing of the grain types is an undesirable way to generate such training images because once the different grain types are mixed, there are no means readily available to separate them again after the training images are captured.

Furthermore, in the grain grading process, grains are cleaned before presenting to the graders. This cleaning process is comprised of multiple stages of filtration using standard sieve sizes. This filtration process is designed in such a way that any material which is either larger than an upper threshold size (too big) or smaller than a lower threshold size (too small), is filtered out of the grains. Anything that is filtered out of the grains is considered dockage or an impurity and is not included in grading analysis. Filtering out grains from a grain sample using physical separation by sieves requires physically handling of the grain, however, in some instance, identification of dockage or impurities in a grain sample is desirable when physical handling of the grain is inaccessible or not readily available.

### SUMMARY OF THE INVENTION

According to one aspect of the present invention there is provided a method of generating training images for use training a grain detection model, the method comprising:
(i) providing a plurality of annotated sample images in which each sample image has been processed to identify object polygons identifying objects in the image and annotated to define a grain characteristic associated with each object polygon;
(ii) providing a starting image having defined boundaries;
(iii) selecting one of the object polygons from one of the annotated sample images and modifying the starting image by placing the selected object polygon relative the boundaries of the starting image;
(iv) repeating step (iii) until a prescribed criterium is met;
(v) responsive to the prescribed criterium being met, storing the modified starting image as a training image ready for use in training the grain detection model.

By digitally creating training images having a mix of polygons from different annotated images, readily available data comprising grain sample images of uniformly annotated grains can be indirectly used for training a detection model while preventing the bias introduced to the model that would otherwise occur if the uniformly annotated images were used directly as training images input into the detection model. Furthermore, training images can be generated that introduce impurities such as other grain types that are physically similar to the grains of the grain sample without physical mixing of the impurities into the grain sample so as to avoid contaminating an actual grain sample with impurities that are subsequently difficult to physically remove.

Preferably (i) a selection of the annotated sample image from which the object polygon is selected and (ii) a selection of the object polygon from the selected annotated sample image, are random selections.

The method preferably further comprises repeating steps (ii) through (v) until all usable object polygons from the annotated sample images have been selected.

The annotated images preferably include some or all uniform images in which each uniform image is configured such that all identified object polygons within the uniform image are uniformly annotated to define the same grain characteristic, but some uniform images have different grain characteristics relative to other uniform images.

In one embodiment, the starting image initially comprises a blank image and the prescribed criterium relates to the starting image being filled with the selected object polygons so that no further object polygons can be fitted within the starting image. In this instance, each selected object polygon may be placed in the starting image by successively repositioning the selected object polygon relative to the boundaries of the starting image to minimize overlap of the selected object polygon relative to other polygons already present in the starting image.

The method may further include minimizing the overlap of the selected object polygon by (i) calculating a cost function that determines overlap between the selected object polygon and said other polygons and repositioning the selected object polygon within the starting image until the calculated cost function falls below a predefined threshold, and (ii) selecting another object polygon from one of the annotated sample images once the calculated cost function falls below the predefined threshold. The method may further include selecting another object polygon from one of the annotated sample images if the calculated cost function does not fall below the predefined threshold after a prescribed number of attempts to reposition the selected object polygon has been met.

According to another embodiment, the starting image comprises a captured image having a plurality of identifiable initial object polygons therein, and the step of placing the selected object polygon within the boundaries of the starting image further comprises replacing a chosen object polygon among the initial object polygons of the sample image with the selected object polygon from the annotated sample images.

Preferably the chosen object polygon of the starting image is chosen among the initial object polygons by identifying one of the initial object polygons that mostly closely matches the selected object polygon from the annotated sample images. More particularly, the initial object polygon that mostly closely matches the selected object polygon may be identified by maximizing an amount of overlap between the initial object polygon and the selected object polygon from the annotated sample images while iteratively translating and/or rotating the initial object polygon relative to the selected object polygon.

In this instance, the prescribed criterium may relate to an amount of overlap between the selected object polygon from the annotated sample images and each of the initial object polygons of the starting image remaining below a prescribed matching threshold.

According to another aspect of the present invention there is provided a method of identifying objects in a grain sample based on a sizing device with sizing apertures, the method comprising:
receiving an image of the sample of grains;
processing the image to identify object polygons in the image representing individual grain objects and impurity objects;
defining a sizing polygon representing an aperture size of the sizing apertures of the sizing device; and
for each object polygon:
   (i) positioning the object polygon relative to the sizing polygon to maximize an intersection of the object polygon with the sizing polygon;
   (ii) calculating an overlap amount between the object polygon and the sizing polygon;
   (iii) comparing the overlap amount to an overlap threshold; and
   (iv) determining the object polygon to be an impurity object if the overlap amount meets the overlap threshold or determining the grain polygon to be a grain polygon for grading if the overlap amount does not meet the overlap threshold.

The method described above allows determination of which grain polygons are considered non-grain, impurities, or other objects and which polygons are considered acceptable grains to be included in subsequent grading analysis without the need to pass grains of the grain sample physically through actual sizing devices such as dockage sieves with object sizing apertures. The sizing analysis can thus be performed without physically handling the grain and based on image data alone.

The method may further include performing grading analysis on the object polygons that are determined to be grain polygons while excluding the object polygons that are determined to be foreign or non-grain object polygons.

The method may further include maximizing said intersection of the object polygon with the sizing polygon by iteratively repositioning the object polygon relative to the sizing polygon by tuning translation and rotation of the object polygon to maximize overlap with the sizing polygon.

When the sizing polygon represents a lower limit polygon for identifying undersized impurity objects, the method preferably includes determining the object polygon to be a non-grain polygon if the overlap amount is greater than the overlap threshold.

When the sizing polygon represents an upper limit polygon for identifying oversized impurity objects, the method preferably includes determining the object polygon to be a non-grain polygon if the overlap amount is less than the overlap threshold.

In one embodiment, the sizing polygon may be defined two separate sizing polygons defined as a lower limit polygon representing an aperture size of an undersized sizing device and an upper limit polygon representing an aperture size of an oversized sizing device.

In this instance the method preferably includes, for each object polygon:
(i) positioning the object polygon relative to the lower limit polygon to maximize an intersection of the object polygon with the lower limit polygon;
(ii) calculating a first overlap amount between the object polygon and the lower limit polygon;
(iii) comparing the first overlap amount to a first overlap threshold;
(iv) determining the object polygon to be a non-grain polygon if the first overlap amount is greater than the first overlap threshold;
(v) positioning the object polygon relative to the upper limit polygon to maximize an intersection of the object polygon with the upper limit polygon;
(vi) calculating a second overlap amount between the object polygon and the upper limit polygon;
(vii) comparing the second overlap amount to a second overlap threshold;
(viii) determining the object polygon to be a non-grain polygon if the second overlap amount is less than the second overlap threshold.

The first overlap threshold and the second overlap threshold may be identical to one another.

According to a further aspect of the present invention, there is provided a system for performing any of the above described methods, the system comprising (i) a memory storing programming instructions, and (ii) at least one processor arranged to execute the programming instructions so as to be configured to execute any of the methods described.

### BRIEF DESCRIPTION OF THE DRAWINGS

Some embodiments of the invention will now be described in conjunction with the accompanying drawings in which:

FIG. 1 is a schematic representation illustrating the use of an algorithm for processing an image of a sample of grain to determine the presence of one or more grain characteristics by outputting a listing of results comprised of identified polygons within the image together with a probability of being associated with one or more classes.

FIG. 2 is a schematic representation of a first embodiment of a grain shuffling algorithm for synthetically generating a training image of grains from a source of annotated sample images of grains with known characteristics such that the resultant training image is suitable for use in training a grain detection model;

FIG. 3 is a flow chart representing steps performed by the grain shuffling algorithm according to the first embodiment of FIG. 2;

FIG. 4 illustrates a plurality of the annotated sample images used by the grain shuffling algorithm and the resultant training image generated according to the first embodiment of the grain shuffling algorithm of FIG. 2;

FIG. 5 is a schematic representation a second embodiment of the grain shuffling algorithm;

FIG. 6 is a schematic representation of the pre-defined placement location for fitting the first object polygon within the boundaries of a blank image defining the starting image when creating a synthetic image according to the first embodiment of the grain shuffling algorithm of FIG. 2;

FIG. 7 is a schematic representation of the starting image after placement of the first object polygon for calculating a cost function before placement of a second object polygon in the starting image according to the first embodiment of the grain shuffling algorithm of FIG. 2;

FIG. 8 is a schematic representation of the starting image after placement of the second object polygon for calculating a cost function before placement of a subsequent object polygon within the starting image according to the first embodiment of the grain shuffling algorithm of FIG. 2;

FIG. 9 is a schematic representation of the starting image after a second placement of the second object polygon within the starting image after the cost function has been optimized so that a subsequent object polygon is ready for placement in the starting image according to the first embodiment of the grain shuffling algorithm of FIG. 2;

FIG. 10 is a schematic representation of a captured image defining the starting image and a selected object polygon from the annotated sample images prior to placement of the selected object polygon in the starting image, according to the second embodiment of the grain shuffling algorithm of FIG. 5;

FIG. 11 is a schematic representation of a chosen object polygon within the starting image that has been chosen for replacement by the selected object polygon from the annotated sample images based on being a closest match according to the second embodiment of the grain shuffling algorithm of FIG. 5;

FIG. 12 is a schematic representation of the starting image after one of the object polygons has been replaced by the selected object polygon from the annotated sample images according to the second embodiment of the grain shuffling algorithm of FIG. 5;

FIG. 13 is a flow chart representing steps performed by a polygon sizing algorithm for virtually sizing object polygons in an image of a grain sample relative to defined sizing polygons that represent sieve sizing apertures of a sizing device without actually passing the grains of the sample through the sizing device;

FIGS. 14 through 17 illustrate an example in which a grain polygon overlaps a lower limit sieve polygon by an amount exceeding a dockage threshold so that the grain polygon is considered undersized waste material, according to a further aspect of the present invention related to identification of non-grain objects within a grain sample;

FIGS. 18 through 21 illustrate an example in which a grain polygon overlaps a lower limit sieve polygon by an amount which does not exceed a dockage threshold so that the grain polygon is not considered waste material.

FIGS. 22 through 25 illustrate an example in which a grain polygon overlaps an upper limit sieve polygon by an amount which does not exceed a dockage threshold so that the grain polygon is considered oversized waste material (dockage).

FIGS. 26 through 29 illustrate an example in which a grain polygon overlaps an upper limit sieve polygon by an amount exceeding a dockage threshold so that the grain polygon is not considered waste material.

In the drawings like characters of reference indicate corresponding parts in the different figures.

### DETAILED DESCRIPTION

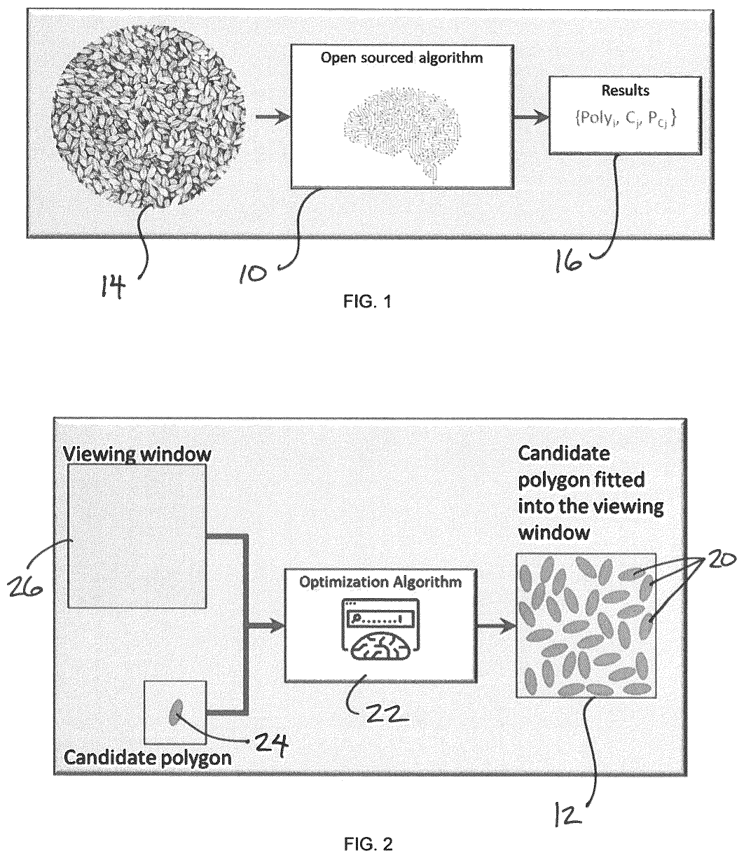

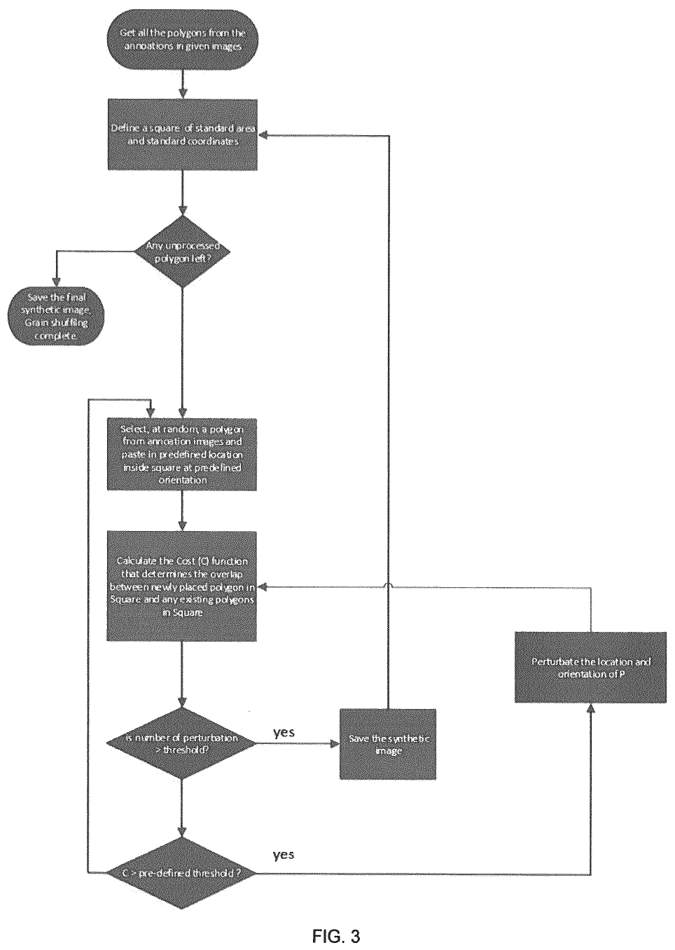

Referring to the accompanying figures, one aspect of the present invention cooperates with a system and method for detecting and classifying grains within a grain sample image according to one or more classes using a grain detection model 10 as represented schematically in FIG. 1, in which each class represents an embodied grain characteristic associated with the class, More particularly, one aspect of the invention relates to a novel system and method for synthetically generating training images 12 used for training the grain detection model.

The present invention further relates to a system comprising (i) a memory storing programming instructions, and (ii) at least one processor arranged to execute the programming instructions so as to be configured to execute any of the methods described herein.

The detection model 10 uses open-sourced deep learning networks to identify and then classify various types of grains and grain characteristics. The overall classification system is represented in FIG. 1. More particularly, the open-source algorithms have been configured and/or modified to define a grain detection model that determines if different grain characteristics are present within grains in a grain sample by processing an image of a grain sample to produce a list of identified polygons which have a respective probability associated therewith the grain characteristic being sought. The detection model 10 takes an image of grains as input and yields a list of results in which each result entry is comprised of a polygon, Polyᵢ, that is the iₜₕ polygon representing one of the detected seed in the image, where i={1, 2, 3, . . . , n}, n being the total number of predictions made by the algorithm. Cⱼ is prediction for seed to possess the characteristic associated with the grain characteristic being sought, that is to be in jₜₕ class where J={0, 1, 2, . . . , m−1}, m being the total number of classes to be predicted. P_{cj} is confidence of prediction in terms of probabilities, for Polyᵢ to be in class Cⱼ.

To optimize the ability of the grain detection model 10 to classify identified object polygons within the images according to one or more object types such as grain type, disease grain, damaged grain, or non-grain impurities, it is important to train the detection model with as many annotated images as possible in which the images comprise grain sample images in which all object polygons in the images have been identified and annotated. Each annotated images 18 include is a uniform image which is configured such that all identified object polygons 20 within the uniform image are uniformly annotated to define the same grain characteristic.

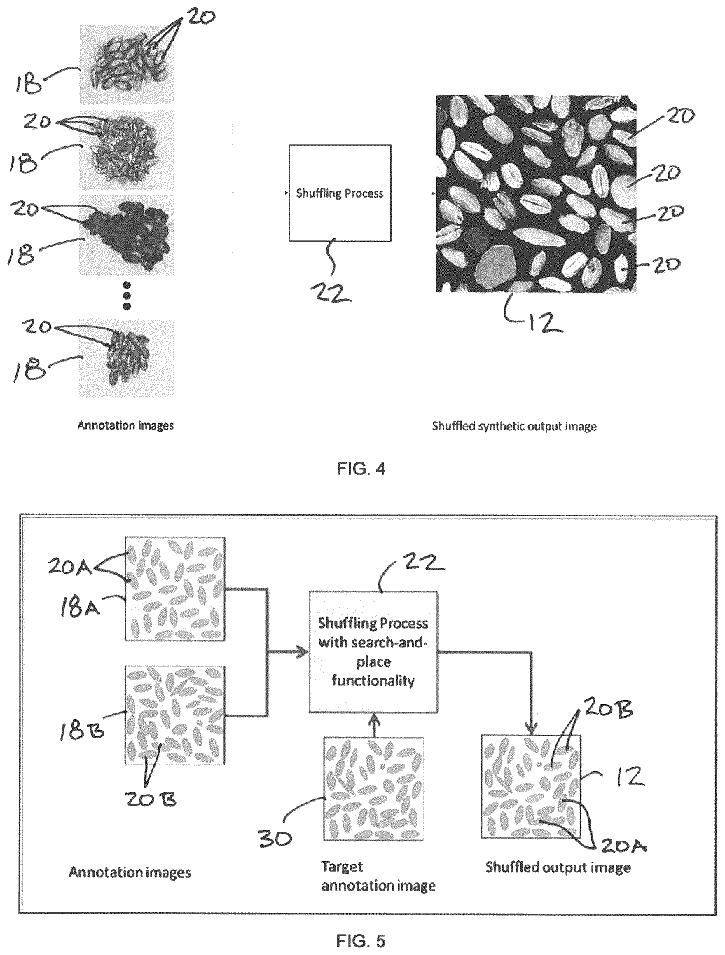

To generate useful training images 12 for training the grain detection model 10 according to the present invention, a set of initial annotated images 18 are generated or acquired in which grains of similar characteristics are grouped together and captured in one image in which all polygons or grains in the image can be identified and annotated with the same identified characteristic as each grain in the image is of same type. These initial annotated images are shown on the left side of FIG. 4 and FIG. 5

It can be seen in FIG. 4 that each of the annotated image contains one type of seeds. The annotations of these images are fed to the shuffling algorithm 22. This algorithm picks random grains from annotations and places them in the generated image 12.

For given kernels (or object polygons 20) in annotation images 18, one candidate polygon 24 is selected at a time and placed in a starting image 26 or viewing window in a way that this candidate polygon does not overlap with any of the existing polygons in the image. The starting image 26 according to a first embodiment of the shuffling algorithm is a blank image. As many polygons as possible are placed in the viewing window before moving on to synthesize the next image (using a blank viewing window). The process is repeated until all the seeds or object polygons 20 from the annotated images 18 are shuffled into newly generated images 12. FIG. 2 provides a high-level overview of the shuffling process.

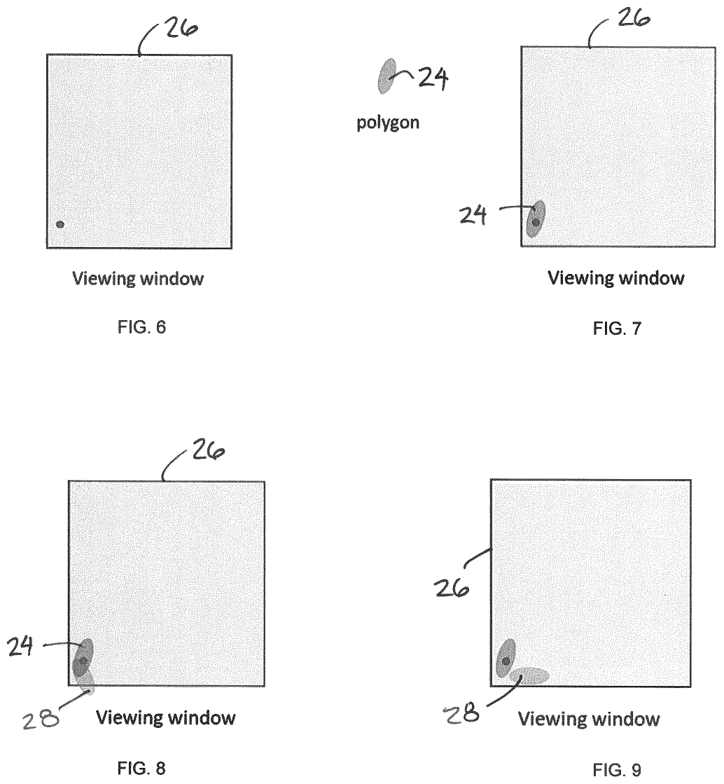

As stated above, according to the first embodiment of the grain shuffling algorithm 22 for generating synthetic training images, the starting image 26 is initial a blank image as shown in FIG. 6. The grain shuffling algorithm then proceeds as follows:

Step 1: Pick up a candidate polygon 24, at random, from annotated images 18. That is, a selection of the annotated sample image from which the object polygon is selected, and a selection of the object polygon from the selected annotated sample image, are random selections.

Step 2: Define a rectangular window of defined dimensions with defined boundaries to define the starting image 26 and the selected candidate polygon 24 as shown in FIG. 6. The small dot inside viewing window is an example of pre-defined location for new polygons to be placed inside the window.

Step 3: Add the copy of the candidate polygon at the predefined location and predefined orientation inside the viewing window as shown in FIG. 7.

Step 4: Calculate the cost function, that minimizes the overlap between newly placed polygon with any existing polygons. In this case, since there are no existing polygons, the cost function is already minimum (=0). Since, the cost function is at its minimum possible value of 0, no further tuning is required for this polygon.

Step 5: Pick a subsequent polygon 28 and paste it at predefined location in viewing window 26 and calculate the cost function. If the polygon is placed exactly on top of first polygon 24, the cost function will be maximum. so the algorithm perturbates the position and orientation of P as shown in FIG. 8 and recalculates the cost function after each repositioning of the subsequent candidate polygon 28. The process is repeated until the cost function is minimized according to FIG. 9 when there is no overlap. Accordingly, each selected object polygon is placed in the starting image by successively repositioning the selected object polygon relative to the boundaries of the starting image to minimize overlap of the selected object polygon relative to other polygons already present in the starting image.

The shuffling algorithm 22 minimizes the overlap of the randomly selected candidate object polygon 28 by calculating a cost function that determines overlap between the selected object polygon 28 and other polygons in the starting image 26 and repositioning the selected object polygon within the starting image until the calculated cost function falls below a predefined threshold forming part of the relevant predefined criteria for determining when to select another object polygon from one of the annotated sample images. Accordingly, the algorithm moves on to select another polygon once the calculated cost function falls below the predefined threshold.

Step 6: The previous step 5 is repeated to add more polygons until further criteria are met. That is, when the viewing window cannot fit more polygons anymore the corresponding criterium is met and the cost function C will not be able to get to the absolute minimum value. In that case, a predefined number of iterations for perturbations will be defined as part of the prescribed criterium to define an absolute stopping condition. The algorithm will thus select another object polygon from one of the annotated sample images if the calculated cost function does not fall below the predefined threshold after a prescribed number of attempts to reposition the selected object polygon has been met. Once the relevant criteria have been met, the viewing window will be saved as a training image 12 ready for training the detection model, and the process will proceed to the next image to be created and saved.

Although there are many possible methods for calculation of the cost function, the following calculation depicts one example of a calculation of the cost function for illustrative purposes. In the illustrative example, when S is the viewing window, P is the currently placed polygon, and pₖ are previous arranged k polygons, then the cost function, that needs to be minimized, is defined as

$$C = \frac{1}{( P ∩ S ) + ε} + {\sum }_{k = 0}^{n - 1} P ∩ {p}_{k}$$

where ε is a small constant added to prevent division-by-zero scenarios, 0.1 as an example in this case. Minimization of this cost function ensures the maximum overlap between candidate polygon 28 and viewing window 26, and minimum overlap between the currently placed polygon 28 and the previously placed polygon 24.

In the instance of the first polygon 24 placed inside the viewing window S, 100% pixels of the polygon are overlapping the viewing window. This makes the P n S=1.0 (a cent percent). Since there are no other previous polygons, n=1 and the term Σₖ₌₀ⁿ⁻¹=P∩pₖ goes down to zero. Since, the cost function C will be at its minimum possible value of

$$\frac{1}{1 + 0.1} = 0.909 ,$$

no further tuning is required for the first polygon.

When adding the subsequent polygon 28 at the predefined location in viewing window, in this instance appearing directly over the first polygon 24 in FIG. 7, calculating the cost function C after initial placement of the second polygon 28 proceeds as follows. Here in this case, the P∩S=1.0 as the new polygon 28 is completely inside the viewing window however, since there are two polygons, n=2, and the term Σₖ₌₀ⁿ⁻¹P∩pₖ=P∩p₁ becomes 1.0 (100%). The total cost function is

$$\frac{1}{1 + 0.1} + 1 = 1.909 .$$

Since the (C=1.909)>(0.909), we perturbate the position and orientation of P as shown FIG. 8 and calculate the Cost function C again. Now, since a portion of P (say 20%) is outside the viewing window, the term P∩S is now 0.8. On other hand, P has 40% overlap with p₁ (the green polygon), then Σₖ₌₀ⁿ⁻¹P∩pₖ=P∩p₁ becomes 0.4. The new value of the cost function after this perturbation is

$$\frac{1}{0.8 + 0.1} + 0.4 = 1.51 .$$

This perturbation has caused the cost function C to go down from 1.909 to 1.51. This process of perturbation will be repeated until the value of cost function C gets to the minimum value of 0.909. One possible result of this optimization is shown in FIG. 9.

Again, the previous steps are repeated to add more polygons. In case when the S cannot fit more polygons anymore, the cost function C will not be able to get to the absolute minimum value of 0.909. In that case, a predefined number of iterations for perturbations will be defined to define an absolute stopping condition. n, the number of polygons in S will be the final count.

According to a second embodiment of the grain shuffling algorithm 22, the starting image 26 may be a content image 30 already filled with existing identifiable object polygons 32 instead of a being a blank image according to the previous embodiment. In this instance, the grain shuffling algorithm performs a search and replace functionality which represents a notable improvement over the prior grain shuffling feature described above.

In an example, illustrated in FIG. 5, there are two annotation images in which the first image 18A includes first polygons 20A of a first type and the second image 18B includes second polygons 20B. The search-and-replace functionality allows placing the object polygons 20 from the annotated images 18 in a target content image that is not an empty or blank image, but rather it can be a real-world image. For example, the target image 30 can be a captured image of mixed grain types which have been identified and annotated, but which may lack a desired polygon type for which it is desirable to train the detection model. For each polygon to be placed, the process involves the following steps: (i) automatically search and identify a matching polygon 34 in target image 30 that is similar to the current polygon (20A, 20B); and (ii) align the current polygon (20A, 20B) with the matching polygon 34 and replace the matching target polygon 34 with current polygon (20A, 20B). It can be seen in FIG. 5 that the selected kernels (20A, 20B) from the annotated images (18A, 18B) replaced the similar kernels from target annotated image 30.

More particularly, the grain shuffling algorithm according to the second embodiment, including a search-and-replace function to generate the synthetic images for training the detection model 10 proceeds as follows:

Step 1: Select a candidate polygon 24, at random, from a randomly selected one of the annotated images 18.

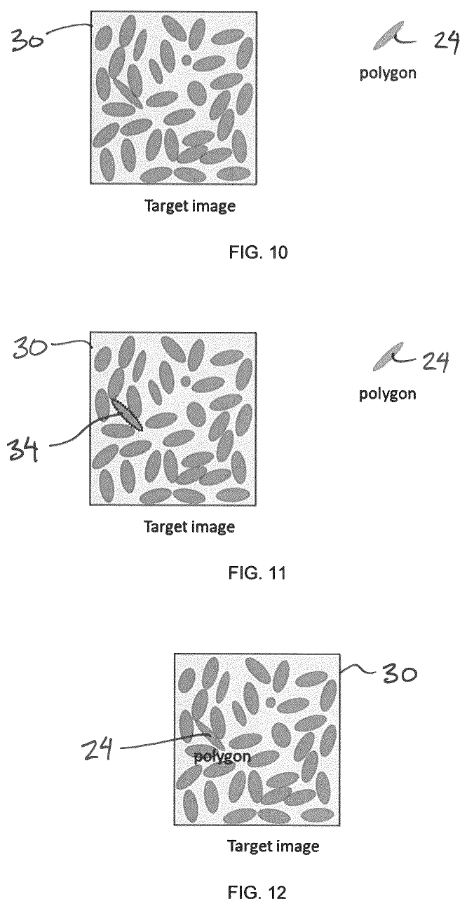

Step 2: Select a target image 30 in which the polygon needs to be placed according to FIG. 10 which illustrates examples of the target image 30 and the selected object polygon 24 from the annotated images.

Step 3: Identify a kernel or object polygon 34 in the target image 30 that is similar to the candidate polygon. This identification process is performed by maximizing the overlapping between the candidate polygon 24 and each of the target polygons in the target image, by tweaking the translation and rotation parameters, in the target image. In this case, the best match or chosen object polygon 34 within the target image is highlighted by dotted boundary. If no kernels in the target image match the required overlap threshold, then the algorithm will move to the next target image in a queue until a match is found.

Step 4: Calculate the transformation between candidate polygon and target polygon. Use that transformation to map the candidate polygon onto the target polygon in the target image. The result of the candidate polygon 24 mapped over top of the matching polygon 34 chosen by maximizing the amount of overlap appears in FIG. 12.

Step 5: Repeat these steps to add more polygons until the target image cannot fit any more polygons from the annotated images anymore or cannot provide a suitable match. A predefined number of iterations for perturbations will be defined to define an absolute stopping condition as a further stopping criterium. The target image will be saved and the process will proceed to the next image.

According to the second embodiment described above, the starting image may comprise a captured image having a plurality of identifiable initial object polygons therein. The step of placing the selected object polygon within the boundaries of the starting image in the second embodiment compared to the first embodiment further involves replacing a chosen object polygon among the initial object polygons of the sample image with the selected object polygon from the annotated sample images. The chosen object polygon to be replaced in the starting image is chosen among the initial object polygons by identifying one of the initial object polygons that mostly closely matches the selected object polygon from the annotated sample images. That is, the initial object polygon that mostly closely matches the selected object polygon is identified by maximizing an amount of overlap between the initial object polygon and the selected object polygon from the annotated sample images while iteratively translating and/or rotating the initial object polygon relative to the selected object polygon. The prescribed criterium to be met before selecting another polygon thus relates to an amount of overlap between (i) the selected object polygon from the annotated sample images and (ii) each of the initial object polygons of the starting image remaining below a prescribed matching threshold.

In each of the above embodiments, the resulting newly generated images 12 are then fed to the detection model 10 described above to further train the model so that the model 10 is better able to distinguish grain characteristics that correspond to the characteristics of the grains represented in the initial annotated images 18. The detection model 10 can then be more accurately used to classify identified grains in grain sample images subsequently classified by the detection model.

Further to the classification of grain sample images using the detection model, once the various object polygons have been identified by predictions and the images are annotated to identify object polygons representing various objects in the image, the next step is to process these object polygons to identify the prospective grain polygons and impurity or non-grain polygons.

Various regulatory bodies relating to the grading of various grains use sizing devices with sizing apertures that allow some material to pass through while restricting the passage of other material to separate grains from both oversized and undersized impurity objects. Sieves are commonly used grain sizing devices having sizing apertures therein which can vary in shape (slotted, circular, and triangular) and size (4.5 to 11). According to one aspect of the present invention there is provided an object sizing apparatus and method for sizing objects within a grain sample image based on sieve aperture shapes and sizes derived from actual grain sizing devices. According to the method, sizing polygons are defined of the required shapes and sizes as per the required tests. For all the seed polygons predicted by the model, the prospective candidate polygons are identified for dockage analysis and for each selected seed polygon, the algorithm iteratively repositions the seed polygon in a way that the intersection between seed polygon and sieve polygon is maximized. The intersection is defined as the percentage amount of the grain polygon that is overlapped by the sieve polygon. After repositioning is completed, the overlap amount is compared with a defined overlap threshold and the seed polygon is classified as dockage or not (dependent upon the overlap amount meeting the relevant threshold). The threshold is set to 80 percent as an example in the illustrated embodiment.

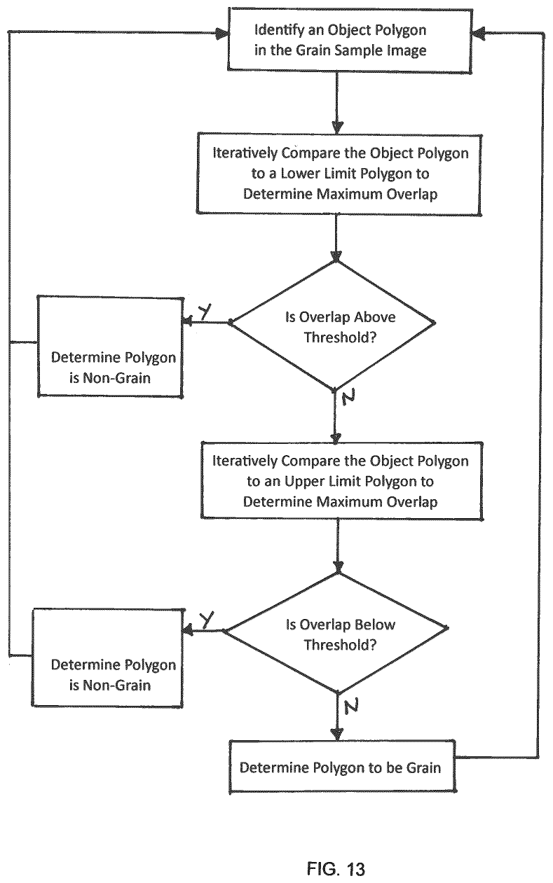

The process executed by the sizing algorithm of FIG. 13 includes selecting each identifiable polygon in a grain sample in sequence and for each polygon, performing a comparative analysis to determine if the selected object polygon is a grain or a non-grain object before repeating the analysis with the next polygon in the image.

As a first step, each grain polygon is compared to a lower limit sieve polygon. This represents the aperture size in a sieve that allows undersized material to pass through that is considered dockage because it is too small to be identified as a grain.

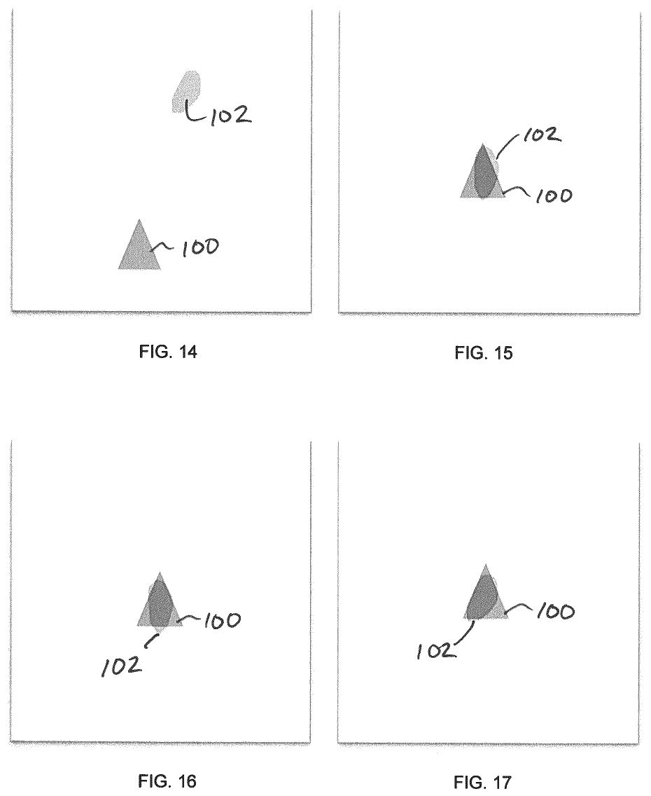

In a first example shown in FIGS. 14 through 17, a first polygon 100 is representing the sieve polygon (triangular in this case) whereas the other object polygon 102 is a candidate seed or grain polygon for dockage analysis. These polygons are arbitrarily placed in closed vicinity of each other initially for dockage analysis. The algorithm takes these polygons and performs Al based optimization to re-position the seed polygon by tuning the translation and rotation parameters of seed polygon in a way to maximize the overlap between the two. The image of FIG. 17 displays the result of this algorithm. In this case, the overlap between the two is 82.1% which is greater that set threshold. Since the object is small compared to sieve and will pass through this sieve, it is identified as dockage. The final solution is not unique and is varied based on randomized states of optimization algorithm. Provided in FIGS. 16 and 17 are some more solutions for the same example with their corresponding overlaps being 87.9% and 92.7% respectively.

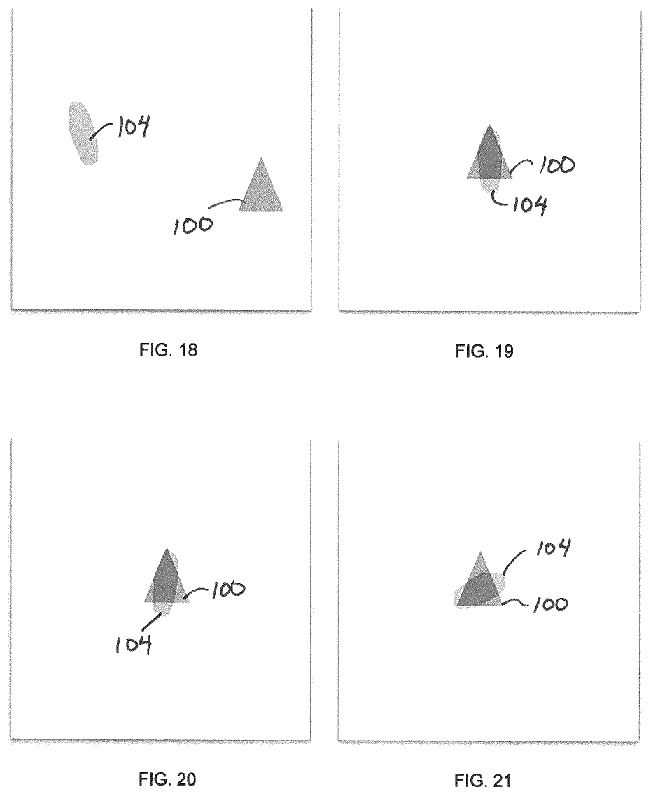

In a second example, another grain polygon 104 is shown compared to the lower limit sieve polygon 100. The initial condition of this example is shown in FIG. 18. Three possible overlapping solutions are shown in FIGS. 19, 20 and 21, in which the overlap is determined to be 73.4%, 73.6%, and 69% respectively. Since, in all three cases, the overlap is less than threshold of 80%, this seed is not classified as dockage.

In a subsequent step, each grain polygon is compared to an upper limit sieve polygon 110. This represents the aperture size in a sieve that blocks passage of oversized waste material therethrough that is considered dockage because it is too large to be identified as a grain.

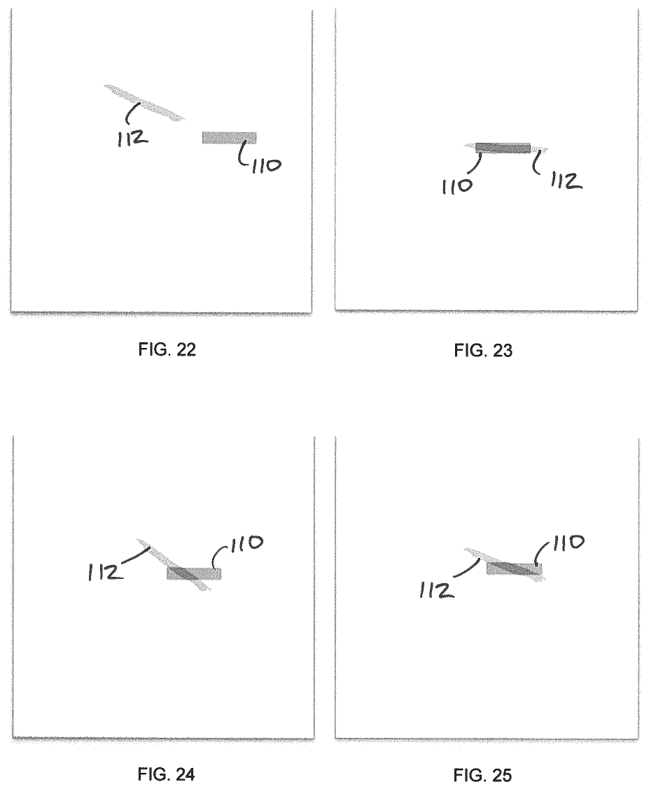

In one example shown in FIGS. 22 through 25, the rectangular polygon 110 is representing the sieve polygon (rectangular in this case) whereas the irregular polygon 112 is a candidate object polygon from the images for dockage analysis. These polygons are arbitrarily placed in closed vicinity of each other initially for dockage analysis. The algorithm takes these polygons and perform Al based optimization to re-position the seed polygon by tuning the translation and rotation parameters of seed polygon in a way to maximize the overlap between the two. The image in FIG. 23 displays the result of this algorithm. In this case, the overlap between the two is 70% which is less that set threshold of 80%. Since it is too big to pass the sieve polygon, it is identified as dockage. The final solution is not unique and is varied based on randomized states of the optimization algorithm. Provided in FIGS. 24 and 25 are some more solutions for the same example with their corresponding overlaps being 28.0% and 44.7% respectively. In all the cases, the overlap is less than 80 percent, and this grain polygon is identified as dockage (too big).

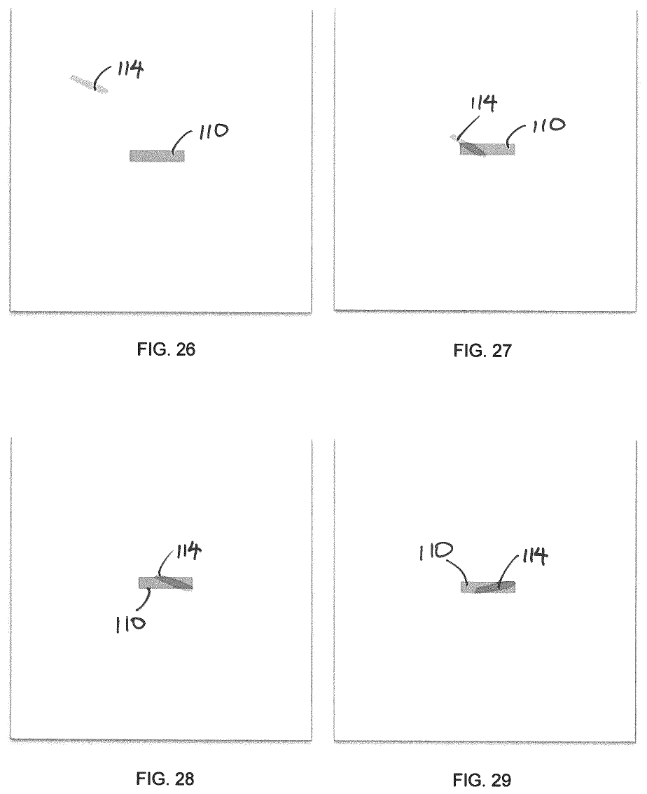

In another example, another grain polygon 114 is shown compared to the upper limit sieve polygon 110. This initial condition is shown in FIG. 26. Three possible overlapping solutions are shown in FIGS. 27, 28 and 30 in which the overlap is determined to be 43.0%, 82.4% and 98%. Since, the overlap is greater than threshold in two instances, this polygon is not classified as dockage and will be included in subsequent grading analysis.

This process is repeated for all polygons in a grain sample image being analyzed for sizing.

The resulting process allows identifying objects in a grain sample based on a sizing device with sizing apertures but without physically passing the grains in the sample through the sizing device or devices. In general, the process includes the steps of (i) receiving an image of the sample of grains, (ii) processing the image to identify object polygons in the image representing individual grain objects and non-grain objects, and (iii) defining a sizing polygon representing an aperture size of the sizing apertures of the sizing device. For each object polygon, the object polygon is repositioned relative to the sizing polygon until an intersection or overlap of the object polygon with the sizing polygon is maximized. The overlap amount between the object polygon and the sizing polygon is calculated and compared to an overlap threshold to determine the object polygon to be a non-grain object if the overlap amount meets the overlap threshold or determining the grain polygon to be a grain polygon for grading if the overlap amount does not meet the overlap threshold. Grading analysis then proceeds only on the object polygons that are determined to be grain polygons, while excluding the object polygons that are determined to be non-grain polygons.

The intersection of the object polygon with the sizing polygon is maximized by iteratively repositioning the object polygon relative to the sizing polygon by tuning translation and rotation of the object polygon to maximize overlap with the sizing polygon. When the sizing polygon represents a lower limit polygon for identifying undersized non-grain objects, the method includes determining the object polygon to be a non-grain polygon if the overlap amount is greater than the overlap threshold. Alternatively, when the sizing polygon represents an upper limit polygon for identifying oversized non-grain objects, the method includes determining the object polygon to be a non-grain polygon if the overlap amount is less than the overlap threshold.

The sizing polygon can also be defined as two different sizing polygons includes a lower limit polygon representing an aperture size of an undersized sizing device and a separate upper limit polygon representing an aperture size of an oversized sizing device. In this instance, each object polygon is positioned relative to each upper and lower limit polygon to maximize the intersection and calculate respective first and second overlap amounts that are compared to respective first and second overlap thresholds to determine if the object polygon is a grain or non-grain polygon. The first overlap threshold and the second overlap threshold may be identical amounts relative to one another.

Since various modifications can be made in the invention as herein above described, and many apparently widely different embodiments of same made, it is intended that all matter contained in the accompanying specification shall be interpreted as illustrative only and not in a limiting sense.

1. A method of generating training images for use training a grain detection model, the method comprising:
(i) providing a plurality of annotated sample images in which each sample image has been processed to identify object polygons identifying objects in the image and annotated to define a grain characteristic associated with each object polygon;
(ii) providing a starting image having defined boundaries;
(iii) selecting one of the object polygons from one of the annotated sample images and modifying the starting image by placing the selected object polygon relative to the boundaries of the starting image;
(iv) repeating step (iii) until a prescribed criterium is met;
(v) responsive to the prescribed criterium being met, storing the modified starting image as a training image ready for use in training the grain detection model.

2. The method according to claim 1 wherein a selection of the annotated sample image from which the object polygon is selected, and a selection of the object polygon from the selected annotated sample image, are random selections.

3. The method according to claim 1 further comprising repeating steps (ii) through (v) until all usable object polygons from the annotated sample images have been selected.

4. The method according to claim 1 wherein the annotated images include some uniform images in which each uniform image is configured such that all identified object polygons within the uniform image are uniformly annotated to define the same grain characteristic.

5. The method according to claim 1 wherein the starting image initially comprises a blank image and wherein the prescribed criterium relates to the starting image being filled with the selected object polygons so that no further object polygons can be fitted within the starting image.

6. The method according to claim 5 wherein each selected object polygon is placed in the starting image by successively repositioning the selected object polygon relative to the boundaries of the starting image to minimize overlap of the selected object polygon relative to other polygons already present in the starting image.

7. The method according to claim 6 including minimizing the overlap of the selected object polygon by calculating a cost function that determines overlap between the selected object polygon and said other polygons and repositioning the selected object polygon within the starting image until the calculated cost function falls below a predefined threshold, and selecting another object polygon from one of the annotated sample images once the calculated cost function falls below the predefined threshold.

8. The method according to 7 including selecting another object polygon from one of the annotated sample images if the calculated cost function does not fall below the predefined threshold after a prescribed number of attempts to reposition the selected object polygon has been met.

9. The method according to claim 1 wherein the starting image comprises a captured image having a plurality of identifiable initial object polygons therein and wherein the step of placing the selected object polygon within the boundaries of the starting image further comprises replacing a chosen object polygon among the initial object polygons of the sample image with the selected object polygon from the annotated sample images.

10. The method according to claim 9 wherein the chosen object polygon of the starting image is chosen among the initial object polygons by identifying one of the initial object polygons that mostly closely matches the selected object polygon from the annotated sample images.

11. The method according to claim 10 wherein the initial object polygon that mostly closely matches the selected object polygon is identified by maximizing an amount of overlap between the initial object polygon and the selected object polygon from the annotated sample images while iteratively translating and/or rotating the initial object polygon relative to the selected object polygon.

12. The method according to claim 10 wherein the prescribed criterium relates to an amount of overlap between the selected object polygon from the annotated sample images and each of the initial object polygons of the starting image remaining below a prescribed matching threshold.

13. A system comprising:
a memory storing programming instructions; and
at least one processor arranged to execute the programming instructions so as to be configured to execute the method according to claim 1.

14. A method of identifying objects in a grain sample based on a sizing device with sizing apertures, the method comprising:
receiving an image of the sample of grains;
processing the image to identify object polygons in the image representing individual grain objects and impurity objects;
defining a sizing polygon representing an aperture size of the sizing apertures of the sizing device; and
for each object polygon:
(i) positioning the object polygon relative to the sizing polygon to maximize an intersection of the object polygon with the sizing polygon;
(ii) calculating an overlap amount between the object polygon and the sizing polygon;
(iii) comparing the overlap amount to an overlap threshold; and
(iv) determining the object polygon to be an impurity object if the overlap amount meets the overlap threshold or determining the grain polygon to be a grain polygon for grading if the overlap amount does not meet the overlap threshold.

15. The method according to claim 14 including performing grading analysis on the object polygons that are determined to be grain polygons while excluding the object polygons that are determined to be non-grain polygons.

16. The method according to claim 14 including maximizing said intersection of the object polygon with the sizing polygon by iteratively repositioning the object polygon relative to the sizing polygon by tuning translation and rotation of the object polygon to maximize overlap with the sizing polygon.

17. The method according to claim 14 wherein the sizing polygon represents a lower limit polygon for identifying undersized impurity objects and wherein the method includes determining the object polygon to be a non-grain polygon if the overlap amount is greater than the overlap threshold.

18. The method according to claim 14 wherein the sizing polygon represents an upper limit polygon for identifying oversized impurity objects and wherein the method includes determining the object polygon to be a non-grain polygon if the overlap amount is less than the overlap threshold.

19. The method according to claim 14 further comprising:
defining the sizing polygon as a lower limit polygon representing an aperture size of an undersized sizing device and a separate upper limit polygon representing an aperture size of an oversized sizing device;
for each object polygon:
(i) positioning the object polygon relative to the lower limit polygon to maximize an intersection of the object polygon with the lower limit polygon;
(ii) calculating a first overlap amount between the object polygon and the lower limit polygon;
(iii) comparing the first overlap amount to a first overlap threshold;
(iv) determining the object polygon to be a non-grain polygon if the first overlap amount is greater than the first overlap threshold;
(v) positioning the object polygon relative to the upper limit polygon to maximize an intersection of the object polygon with the upper limit polygon;
(vi) calculating a second overlap amount between the object polygon and the upper limit polygon;
(vii) comparing the second overlap amount to a second overlap threshold;
(viii) determining the object polygon to be a non-grain polygon if the second overlap amount is less than the second overlap threshold.

20. The method according to claim 19 wherein the first overlap threshold and the second overlap threshold are identical to one another.

21. A system comprising:
a memory storing programming instructions; and
at least one processor arranged to execute the programming instructions so as to be configured to execute the method according to claim 14.
